(19) United States
(12) Patent Application Publication
(10) Pub. No.: US 2010/0271497 A1
(43) Pub. Date: Oct. 28, 2010

(54) PORTABLE TRAFFIC MONITORING SYSTEM AND METHODS FOR USE

(76) Inventor: Michael G. Monsive, JR., Cypress, TX (US)

Correspondence Address: PATTERSON & SHERIDAN, L.L.P., 3040 POST OAK BOULEVARD, SUITE 1500, HOUSTON, TX, 77056, US

(21) Appl. No.: 12/769,415

(22) Filed: Apr. 28, 2010

Related U.S. Application Data
(60) Provisional application No. 61/173,467, filed on Apr. 28, 2009.

(51) Int. Cl. H04N 5/232

(52) U.S. Cl. 348/211.99; 348/E05.042

(57) ABSTRACT

Certain embodiments of the present disclosure provide a traffic monitoring system and methods of use. This traffic monitoring system may be suitable for automatic monitoring of vehicle traffic at desired locations such as, for example, traffic lights, school zones, construction zones, remote locations, locations having high traffic accidents and/or locations with frequent traffic violations. The traffic monitoring system may be employed for detecting traffic violations involving a vehicle (e.g., running a red light, speeding and/or driving while using a cell phone) and collecting information associated with the vehicle and/or the operator of the vehicle. The traffic monitoring system may include one or more portability features that may make this system well-suited for deployment and redeployment at any number of desired locations, for example where traffic monitoring is desirable but suitable permanent infrastructure is not in place or is cost prohibitive.

### CROSS-REFERENCE TO RELATED APPLICATION

This application claims benefit of U.S. Provisional Patent Application Ser. No. 61/173,467 filed Apr. 28, 2009, which is incorporated herein by reference.

### BACKGROUND OF THE INVENTION

1. Field of the Invention

Embodiments of the present invention generally relate to vehicle traffic monitoring and, more particularly, to a portable traffic monitoring system.

2. Description of the Related Art

Enforcement of traffic laws is a major undertaking around the world. Non-compliant driving behavior, such as speeding and red light running, may cause serious damage to life and property. Various techniques may be utilized for monitoring vehicle traffic in an effort to minimize the damages caused by such non-compliant driving behavior.

Conventional techniques for monitoring vehicle traffic may involve human intervention. For example, a police officer may identify speeding vehicles by following the vehicle or by employing speed detection devices.

### SUMMARY OF THE INVENTION

According to an aspect of the present disclosure, a system for monitoring traffic is provided. The system generally includes a portable base unit comprising a control unit and at least one camera coupled to the portable base unit. The control unit is typically configured to identify a traffic violation in a traffic monitoring location and to control the at least one camera to capture at least one image corresponding to the traffic violation.

According to another aspect of the present disclosure, a method for monitoring traffic is provided. The method generally includes monitoring a traffic monitoring location with a portable traffic monitoring apparatus—wherein the portable traffic monitoring apparatus generally includes a portable base unit having a control unit and a camera coupled to the portable base unit,—detecting a traffic violation at the traffic monitoring location with the control unit, and capturing, with the camera, at least one image corresponding to the traffic violation.

According to another aspect of the present disclosure, a portable apparatus for monitoring traffic is provided. The apparatus generally includes means for allowing deployment of the apparatus at a traffic monitoring location, means for detecting a traffic violation at the traffic monitoring location, and means for capturing at least one image corresponding to the traffic violation.

### BRIEF DESCRIPTION OF THE DRAWINGS

A more particular description of the invention, briefly summarized above, may be had by reference to the embodiments thereof, which are illustrated in the appended drawings. It is to be noted, however, that the appended drawings illustrate only typical embodiments of the invention and are, therefore, not to be considered limiting in its scope, for the invention may admit to other equally effective embodiments.

FIGS. 1 and 2 illustrate traffic violation monitoring in accordance with certain embodiments of the present disclosure.

FIG. 3 illustrates a speed detection device in accordance with certain embodiments of the present disclosure.

FIG. 4 illustrates an example traffic monitoring system in accordance with certain embodiments of the present disclosure.

FIG. 5 illustrates an example of transferring information from a traffic monitoring system to a remote unit in accordance with certain embodiments of the present disclosure.

FIG. 6 illustrates example operations for monitoring traffic in accordance with certain embodiments of the present disclosure.

FIG. 7 illustrates example operations for monitoring traffic in accordance with certain embodiments of the present disclosure.

### DETAILED DESCRIPTION

Certain embodiments of the present disclosure provide a traffic monitoring system, and methods of use. This traffic monitoring system may be suitable for automatic monitoring of vehicle traffic at desired locations such as, for example, traffic lights, school zones, construction zones, remote locations, locations having high traffic accidents and/or locations with frequent traffic violations. The traffic monitoring system may be employed for detecting traffic violations involving a vehicle (e.g., running a red light, speeding and/or driving while using a cell phone) and collecting information associated with the vehicle and/or the operator of the vehicle. The traffic monitoring system may include one or more portability features that may make this system well-suited for deployment and redeployment at any number of desired locations, for example where traffic monitoring is desirable but suitable permanent infrastructure is not in place.

### Automatic Traffic Monitoring

As described above, conventional techniques for monitoring vehicle traffic may involve human intervention. Such techniques may have certain disadvantages. For example, while employing personnel (e.g., police officers) for monitoring traffic violations, the number of personnel may be limited. As a result, it is likely that many traffic violations may go unnoticed. Accordingly, techniques and apparatus that facilitate monitoring of vehicle traffic with minimal human intervention may be desirable.

Certain embodiments of the present disclosure may provide a traffic monitoring system that may perform monitoring of vehicle traffic in an automatic manner. In other words, vehicle traffic monitoring may be accomplished with little or no human intervention. The traffic monitoring system may detect traffic violations involving vehicles and collect information about the vehicles and/or operators of the vehicles. The traffic monitoring system may be suitable for deployment at traffic lights, school zones, construction zones, rural locations, and anywhere else where it may be desirable to monitor traffic. According to certain embodiments, the portability of the traffic monitoring system allows it to be redeployed when traffic monitoring is no longer desirable at a particular location, such as, for example, when construction at a construction zone is completed

According to some embodiments, it may be desirable to monitor traffic without the cost of installing permanent cameras at traffic lights. Furthermore, a local government or enforcement agency may determine that the disclosed traffic monitoring system will free enforcement personnel to be deployed to other areas of need. In some embodiments, such enforcement personnel may oversee traffic monitoring more efficiently, such as at a remote location which may receive traffic monitoring information from several portable traffic monitoring units deployed at various locations. According to certain embodiments, it may be desirable to redeploy the disclosed traffic monitoring system at different locations from time to time, for example, so that traffic enforcement might be unpredictable to vehicle operators, resulting in higher compliance with traffic laws. Traffic violations may contribute to traffic accidents. Thus, in some embodiments, the traffic monitoring system may be deployed in areas with historically high numbers of traffic accidents and/or traffic violations such as speeding, red-light violations or other traffic violations which may be monitored with the disclosed system.

In some embodiments, the disclosed traffic monitoring system may be utilized to monitor the vehicle operator behavior for traffic violations, such as in locations where cell phone use while driving is prohibited. For example, in some locations, cell phone use while driving in school zones is prohibited during school hours. According to embodiments of the present disclosure, a portable traffic monitoring system may be deployed at such a location when traffic monitoring is desirable, and redeployed elsewhere when traffic monitoring is unnecessary, for example, when school is out of session or during non-school hours.

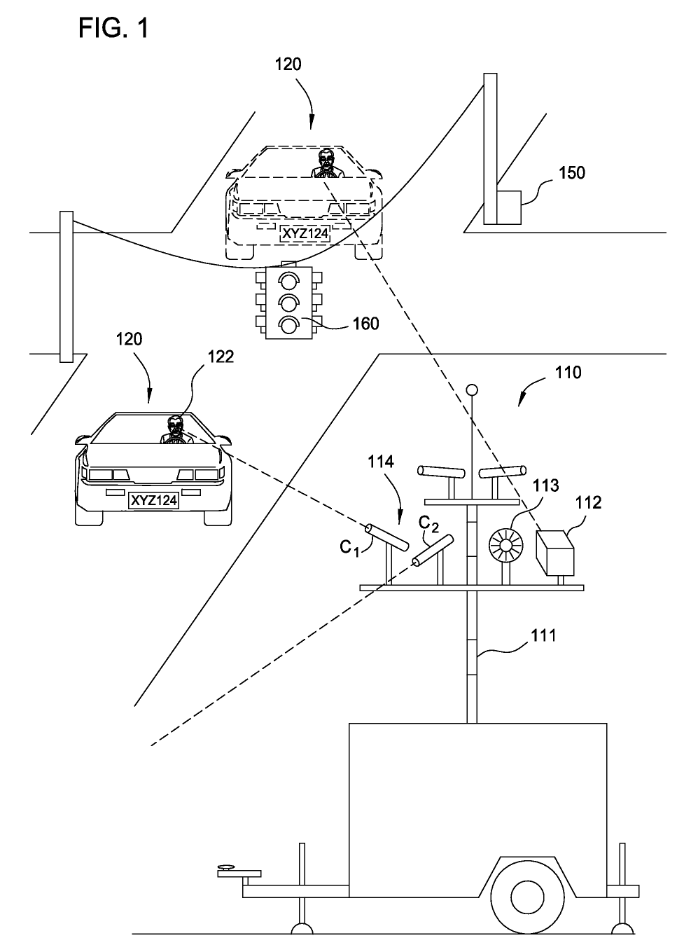

FIG. 1 illustrates a traffic monitoring system 110 suitable for automatically monitoring traffic violations involving a motor vehicle travelling on a road. The traffic monitoring system 110 may be deployed at a desirable traffic monitoring location. For example, the traffic monitoring system 110 may be deployed near an intersection where a view of each of the four (or more) directions of travel is provided. As another example, the traffic monitoring system 110 may be deployed on the side of a road where frequent instances of speeding may be suspected. In some embodiments, the traffic monitoring system 110 may be deployed at a construction zone or a school zone. In some embodiments, the traffic monitoring system 110 may be redeployed at another desired traffic monitoring location.

To facilitate automatic detection of speeding violations, the traffic monitoring system 110 may include one or more speed detection devices such as the device 112 mounted on pole 111, as illustrated in FIG. 1. Devices capable of determining the speed of an approaching vehicle by directing energy (e.g., radio waves, microwaves, or laser) at the vehicle may be utilized as the speed detection device 112. The speed detection device 112 may be continuously, periodically, or intermittently active to detect an approaching vehicle such as the vehicle 120 depicted in FIG. 1. When the vehicle 120, operated by an operator 122, enters the field of the speed detection device 112, the device 112 may determine the speed of the vehicle 120. If the determined speed is greater than a predetermined value (e.g., the legal speed limit), one or more cameras 114 may be activated for collecting information about the vehicle 120 and/or the operator 122.

The cameras 114 may be fixed cameras with zooming capabilities, built-in infrared (IR) for nighttime imaging, or a combination thereof. In some embodiments of the traffic monitoring system 110, cameras 114 with panning/tilting/zooming (PTZ) capabilities may be employed. Images collected by the cameras 114 may be in the form of pictures and/or video recordings. As an example, a camera C1 may be activated to capture a snapshot of the operator 122 of the vehicle 120 as illustrated in FIG. 1. Some embodiments of the cameras 114 may include high-resolution capabilities in an effort to enhance the quality of the images captured.

In some locations, such as in school zones or in an entire geographic region, it may be against the law to operate a vehicle while using a hand-held cell phone or other portable electronic devices. Thus, according to some embodiments, the camera C1 may be utilized to monitor whether an operator 122 of the vehicle 120 is using a cell phone. If the operator 122 is using a cell phone while driving, the camera C1 may record one or more images depicting such use.

In addition to, or instead of, collecting information about the operator 122, information about the vehicle 120 may be collected. Such information may include, for example, license plate information of the vehicle 120. For example, camera C1 may be activated to capture an image of the front license plate. Additionally, or alternatively, as illustrated in FIG. 2, a second camera C2 may be activated to capture an image of the rear license plate 202 of the vehicle 120. Certain embodiments of the traffic monitoring system 110 may include one or more flash units 113. The flash unit 113 may assist the cameras 114 during poor light conditions and/or in capturing images of reflective license plates. The flash unit 113 may utilize invisible or low-visibility wavelengths, such as infrared or near-infrared, to minimize disruption to traffic while still providing sufficient exposure for image capture by camera 114.

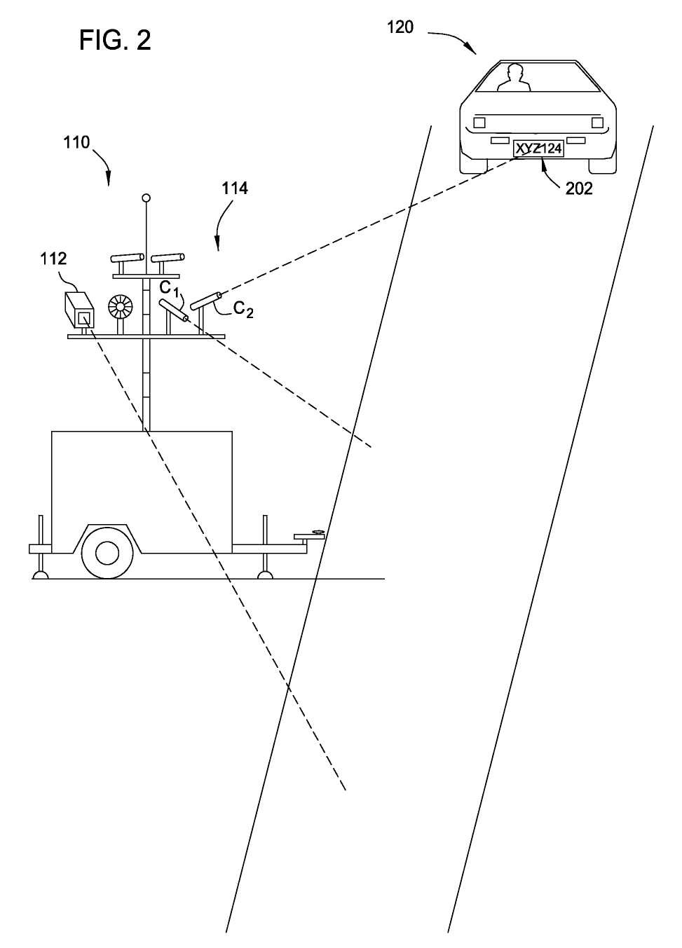

Certain embodiments of the traffic monitoring system 110 may allow rotation of the speed detection device 112 for facilitating monitoring of speeding vehicles in more than one direction. For example, the speed detection device 112 may rotate by angle α as illustrated in FIG. 3. Angle α may be a suitable angle that may allow monitoring of speeding vehicles in, for example, both directions of a road. Accordingly, the traffic monitoring system 110 may be deployed on either side of the road for determining the speed of an approaching vehicle.

According to certain embodiments, the traffic monitoring system 110 may bolster the capabilities of an existing traffic coordination system in monitoring traffic conditions and/or traffic violations. As an example, the traffic monitoring system 110 may be deployed at traffic lights for monitoring traffic violations such as a vehicle crossing an intersection against a traffic light 160. To accomplish this, information associated with traffic signal states and/or transitions may be obtained, for example, from a traffic control unit 150 associated with a traffic light 160. The traffic monitoring system 110 may receive information from the traffic control unit 150 via a wireless or wired transmission. Based on the obtained information, the cameras C1 and/or C2 may be active for a certain duration, such as when a light is red or for a certain period after the light turns red. In an alternate embodiment, the cameras C1 and/or C2 may be active only when a vehicle crossing against the light 160 is detected. According to some embodiments, the cameras C1 and/or C2 may monitor the intersection continuously, while recording one or more images only when a traffic light violation has occurred. The traffic monitoring system 110 may be deployed in such a manner that a vehicle attempting to cross against the light 160 will do so by necessarily entering the field of the cameras C1 and/or C2. This may trigger the cameras C1 and/or C2 to collect one or more images of the vehicle and/or the operator of the vehicle in the manner described above.

According to some embodiments, the traffic monitoring system 110 may utilize the speed detection device 112 to determine whether a vehicle has crossed against the light 160. For example, the traffic monitoring system 110 may receive information regarding traffic light state (e.g., green or red) and the speed detection device 112 may indicate whether a vehicle is moving in the intersection.

### An Example Portable Traffic Monitoring System

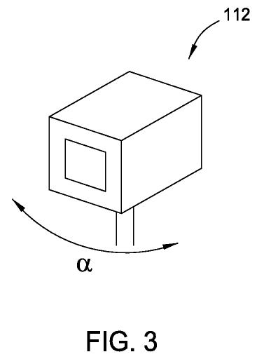

FIG. 4 illustrates an example traffic monitoring system 110 in accordance with certain embodiments. In addition to the speed detection device 112 and the cameras C1 and C2, the traffic monitoring system 110 may comprise a base unit 410. The base unit 410 may act as a shield protecting one or more of the components of the traffic monitoring system 110 from dust, water, and the like. For some embodiments, the base unit 410 may comprise metal in an effort to shield the internal components from electromagnetic (EM) radiation. The base unit 410 may comprise a power unit 412 and a control unit 414 as illustrated in FIG. 4. The traffic monitoring system may include one or more portability features as described below. Such features may make the traffic monitoring system 110 suitable for deployment and redeployment at any number of desired locations.

The control unit 414 may include means for activating the cameras C1 and C2 based on signals obtained from the speed detection device 112. Such means may comprise one or more devices, such as a processor or microcontroller, capable of detecting speeding alerts contained in the signals and, in response, activating the cameras C1 and C2 with one or more trigger signals. Signals from the cameras C1 and C2 may be transferred to the control unit 414 via one or more signal cables 420. Such means may also be employed for controlling the operations of the cameras 114. For example, if cameras 114 with PTZ capabilities are used, the control unit 414 may manipulate the panning, tilting, and/or zooming of the cameras 114. To perform such control operations, the control unit 414 may issue one or more control signals. These control signals and/or the trigger signals may be output from the control unit 414 to the cameras C1 and C2 via the signal cables 420. For some embodiments, one or more control signal cables, separate from the signal cables 420, may be used for this purpose.

The control unit 414 may also comprise means for locally storing information collected by the cameras C1 and C2. The means for locally storing such information may comprise any of various suitable storage devices, such as a hard disk, magnetic tape, Random Access Memory (RAM), and flash memory. The information collected by the cameras C1 and C2 may be transferred to the control unit 414 via the signal cables 420. For some embodiments, one or more data cables, separate from the signal cables 420, may be used for this purpose.

The power unit 412 may provide power to the various components of the traffic monitoring system 110 via one or more power cables 418. For some embodiments, the power unit 412 may comprise means for receiving power from one or more external power sources (e.g., power from power lines of an electric grid, stepped down by a transformer). Such means may comprise arrangements, such as an electrical socket, capable of electrically connecting the power unit 412 and an external power source. In other embodiments, the power unit 412 may comprise one or more batteries that may act as a stand-alone power source or that may be used together with power from external power sources for powering the traffic monitoring system 110.

In certain embodiments, the power unit 412 may comprise a chargeable power source, a charging power source, and one or more components for controlling charging of the chargeable power source. The chargeable power source may be configured to power the components of the traffic monitoring system 110. The chargeable power source may be any of various suitable devices capable of being repeatedly recharged and supplying sufficient power. In some embodiments, the chargeable power source may comprise one or more rechargeable batteries. Any of various types of rechargeable batteries may be used. For example, the chargeable power source may comprise one or more gel batteries (also known as gel cells), which contain battery acid in a gel form. For other embodiments, the chargeable power source may comprise other types of lead-acid batteries, such as one or more absorbent glass mat (AGM) lead-acid batteries. The terminals of the chargeable power source may be connected with the components of the traffic monitoring system 110 in an effort to provide power to these components.

The charging power source may provide means to charge the chargeable power source. The charging power source may comprise any of various suitable power sources, such as generators that may convert mechanical energy into electrical energy, solar cells that may convert solar energy into electrical energy, etc., used alone or in combination. For some embodiments, the charging power source may comprise an engine driving an alternator to charge the chargeable power source, similar to the engine/alternator/battery combination in a modern automobile. For other embodiments, the charging power source may comprise an engine-generator set (gen-set), which is the combination of an engine driving an electrical generator. The engine of the gen-set may comprise a diesel engine or an internal combustion engine (ICE) using any suitable fuel source, such as gasoline. The engine may comprise a single-cylinder or multiple cylinders and may be liquid-cooled or air-cooled. In addition to the engine and alternator, such a charging power source may include a fuel tank, an engine speed regulator, an alternator voltage regulator, cooling and exhaust systems, and a lubrication system. In the embodiments of charging power sources having an engine described above, the chargeable power source or a separate source (e.g., a battery) may provide power to a starter motor for powering on the engine.

For other embodiments, the charging power source may comprise a gas engine generator (GEG) where the mechanical energy powering the electrical generator is heat energy from the burning of a gas. For example, the gas burned in a GEG may be natural gas or propane (liquid or gas).

As the efficiency of solar cells continues to improve, the charging power source may comprise one or more solar panels in some embodiments. Each solar panel may comprise several solar cells and may be mounted on an upper or angled lateral surface of the traffic monitoring system 110.

Certain embodiments of the present disclosure may provide means for supporting the speed detection device 112 along with cameras 114 such as the cameras C1 and C2 at a suitable height above the base unit 410 in an effort to offer a clear view of a vehicle in the vicinity of the traffic monitoring system 110. For example, a mast or a pole 402 may support the speed detection device 112 and the cameras 114 when mounted on the base unit 410. The pole 402 may be removable from or statically mounted on the base unit 410. For some embodiments, the pole 402 may have a fixed length (e.g., 6 feet to 7 feet, or 1.83 m to 2.13 m). For other embodiments, the pole 402 may be a telescoping structure allowing the height of the speed detection device 112 and the cameras 114 to be adjusted. For example, a galvanized three-section-telescoping pole with adjustable height may be used. Means for telescoping the pole 402 may include any of various suitable components for adjusting the height of the pole 402, such as electric winches, air cables, manual winches, or a twist lock. For example, the height of the pole 402 may be adjusted using a dual winch system. For some embodiments of the traffic monitoring system 110, an eyelet may be included for raising the pole 402.

Certain embodiments of the traffic monitoring system 110 may further include one or more surveillance devices such as cameras and sound recorders. As an example, cameras 114 such as cameras C3 and C4 illustrated in FIG. 4 may be used as the surveillance devices. The cameras C3 and C4 may be supported above, below or at a similar level as the cameras C1 and C2 by the pole 402 or a second pole (not shown). The cameras C3 and C4 may monitor the surroundings for purposes such as detecting and/or preventing damage or disabling of the traffic monitoring system 110 by, for example, a passerby. In certain embodiments, such cameras may be pointed downwards in an effort to monitor the immediate vicinity and/or the rest of the traffic monitoring system 110. Information collected by surveillance devices, such as the cameras C3 and C4, may be carried to the control unit 414 via the signal cables 420 or one or more data cables that are separate from the signal cables 420. The control unit 414 may comprise means for analyzing the received surveillance data. Such means may include any of various suitable processing devices (e.g., sound processors and image processors).

The control unit 414 may act based on the results of such analysis operations. For example, if a suspicious activity is detected, the control unit 414 may choose to activate one or more alarms (silent or audible) included in the traffic monitoring system 110. For some embodiments, the control unit 414 may activate one or more remote alarms that may be mounted away (e.g., at a remote monitoring station) from the traffic monitoring system 110. The information collected by the surveillance devices and/or results of the analysis operations may be stored locally at the control unit 414, for later retrieval. In certain embodiments of the traffic monitoring system 110, one or more storage/recording devices separate from the control unit 414 may be employed for this purpose. As an example, video data collected by the cameras C3 and C4 may be stored/recorded in one or more digital video recorders (DVR) such as the DVR 416 illustrated in FIG. 4. The video data may be transferred to the DVR 416 via one or more video cables 422. In certain embodiments, the cameras C3 and C4 may also be utilized for monitoring traffic conditions by, for example, recording information (e.g., in the form of videos) about approaching traffic.

In the example illustrated in FIG. 4, the cables 418, 420, 422 may pass through the poles 402. The poles 402 may be hollow to facilitate this. However, in certain embodiments, the traffic monitoring system 110 may include a tube or duct, separate from the poles 402, to convey such cables to the various components of the traffic monitoring system 110. In some embodiments, the cables may be wound around the poles 402.

In some embodiments of the present disclosure, the traffic monitoring system 110 may comprise means for allowing deployment of the system 110, i.e., allowing for movement of the system to a desired traffic monitoring location and placement into a desired operational position. For example, a trailer assembly with wheels 426 as depicted in FIG. 4 may be used. Such a trailer assembly may comprise any of various suitable components for transporting and/or operating the traffic monitoring system 110. These may include any combination of the following: rear outriggers, a tongue jack, a lifting eye, taillights, and the like. Some embodiments may use a sturdy trailer assembly that may be operational in wind gusts up to about 65 mph (104.6 kilometers per hour). For example, the trailer assembly may comprise rear outriggers 428 for stabilizing the structure during strong wind gusts or when placed on an uneven surface. In some embodiments, one or more height-adjustable outriggers may replace the trailer assembly. Such outriggers may stabilize the structure in a similar manner. Some embodiments may include means for allowing transportation and/or deployment of the traffic monitoring system 110 in a wheel-less manner. These means may include arrangements such as skids, skis or sleds, and legs. Such means may facilitate transportation of the traffic monitoring system during, for example, inclement weather conditions.

Some embodiments of the traffic monitoring system 110 may include means for transmitting information collected by the speed detection device 112 and/or devices such as the cameras C1, C2, C3, and C4 to a remote unit (e.g., remote servers, PCs, and workstations). The remote unit may be located at, for example, a traffic monitoring station. An advantage of transmitting the information to the remote unit is that retrieval and/or storage of the information may be performed remotely. Furthermore, instead of locally storing the information collected at individual traffic monitoring systems 110 deployed at different locations, the information may be centrally stored at the remote unit, thereby reducing costs associated with providing memory and/or data storage equipment for each of the traffic monitoring systems 110. Such an approach may also facilitate remote monitoring of traffic violations. In some embodiments, the traffic monitoring system 110 may send an e-mail, text message (Short Message Service, or SMS), picture message (Multimedia Messaging Service, or MMS) or a paging notification to a remote site or unit when a traffic violation or an attempt to disable/steal the traffic monitoring system 110 is detected.

Means for transmitting the information to the remote unit may include mechanisms such as antennas and transceivers (or transmitters). FIG. 4 illustrates such an antenna 424. The transmission may be performed via any of various suitable communication standards or technologies. For example, some embodiments of the present disclosure may include high speed cellular, General Packet Radio Service (GPRS), Enhanced Data rates for Global Evolution (EDGE), satellite, Wi-Fi, WiMAX (Worldwide Interoperability for Microwave Access), mesh, and/or local area network (LAN) capabilities, which, the traffic monitoring system 110 may utilize for communication purposes.

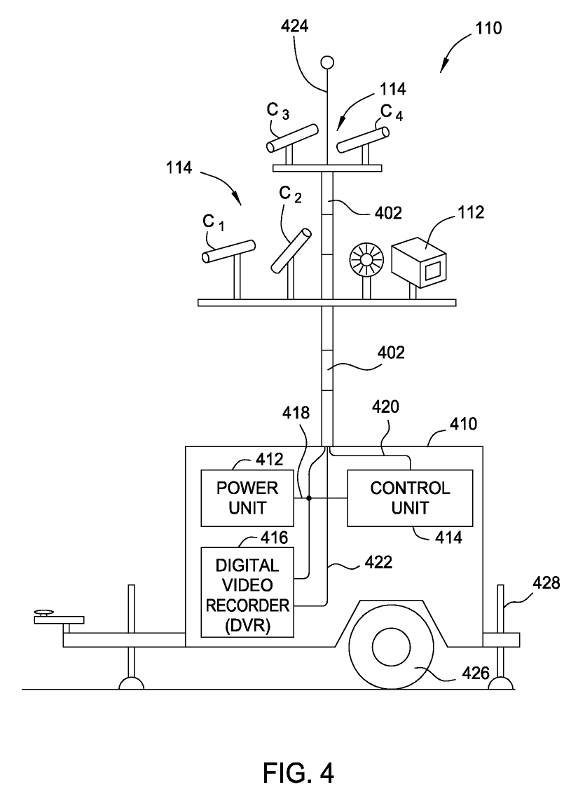

FIG. 5 illustrates an example of transmitting at least a portion of the collected information to a remote unit. In the example illustrated, the remote unit may be a network video recorder (NVR) 510. The NVR 510 may be utilized for storing video data collected by the cameras included in the traffic monitoring system 110. The traffic monitoring system 110 may transfer the video data collected by the cameras to the NVR 510 by transmitting one or more signals 502 as illustrated in FIG. 5. The signals 502 may be received by the NVR 510 by utilizing a receiver antenna 512 as illustrated in FIG. 5. The video data contained in the signals 502 may be recorded at the NVR 510 for later retrieval.

In addition to, or instead of the surveillance devices and alarms described above, certain embodiments of the traffic monitoring system 110 may include one or more security features for purposes such as preventing the traffic monitoring system 110 or one or more of the individual components from being stolen. Such features may also aid in tracking a stolen traffic monitoring system 110. These features may include any combination of the following: a removable hitch, heavy duty locks on the trailer assembly, global positioning system (GPS) tracking, LoJack, and the like.

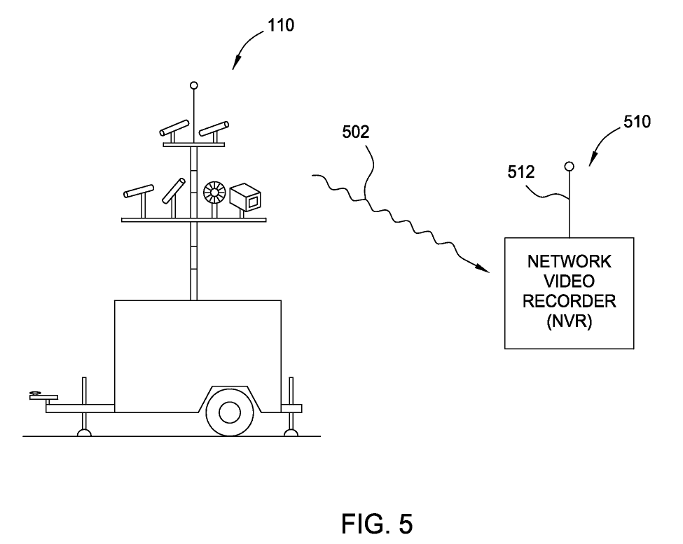

FIG. 6 illustrates example operations 600 for monitoring traffic with the disclosed traffic monitoring system, according to certain embodiments. At 602, a traffic monitoring system, such as described above, is deployed proximate to a desired traffic monitoring location. At 604, the traffic monitoring system receives via the control unit 414 a traffic signal state from a traffic control device 160. At 606, the traffic monitoring system selectively monitors the traffic monitoring location based on the traffic signal state. For example, according to some embodiments, the traffic monitoring location may be monitored only when the traffic signal state is red. According to some embodiments, a first portion of the traffic monitoring location may be monitored while the traffic signal state is red with respect to the first portion, while a second portion of the traffic monitoring location may be monitored while the traffic signal state is red with respect to the second portion. At 608, based upon the detection of a vehicle in the traffic monitoring location against the traffic signal state (e.g., entering or crossing the intersection on a red light), at least one image of the vehicle may be recorded with a camera 114. According to some embodiments, the image may be stored in a storage unit located on the traffic monitoring system, such as in the base unit 410. According to other embodiments, the image may be transmitted to a remote location for storage.

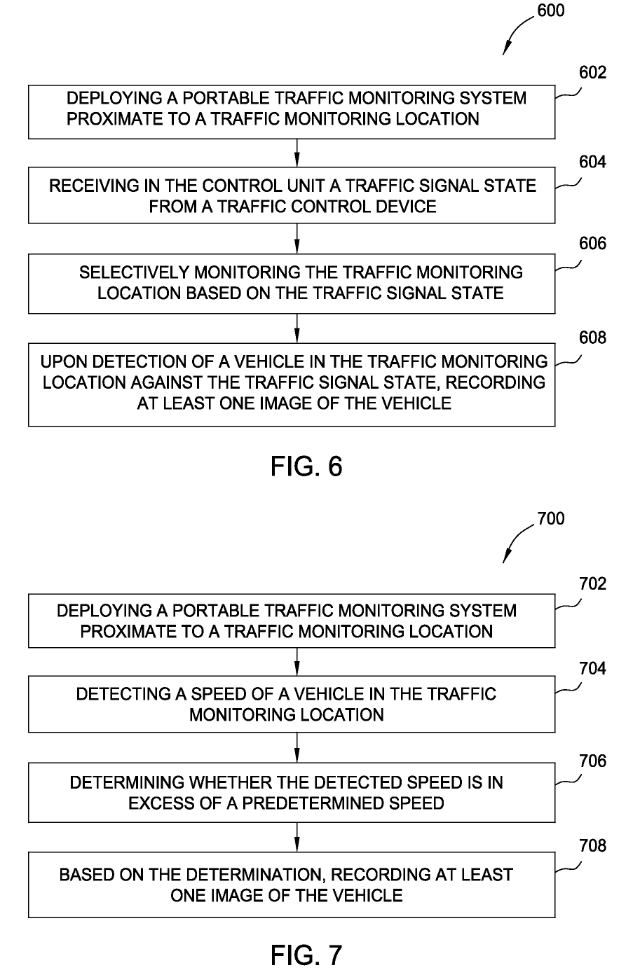

FIG. 7 illustrates example operations 700 for monitoring traffic with the disclosed traffic monitoring system, according to certain embodiments. At 702, a traffic monitoring system, such as described above, is deployed proximate to a desired traffic monitoring location. At 704, the traffic monitoring system detects a speed of a vehicle in the traffic monitoring location with the speed detection device 112. At 706, the traffic monitoring system determines whether the detected speed is in excess of a predetermined speed (such as the legal speed limit) by a threshold, where the threshold may be zero for some embodiments. At 708, based on the determination, at least one image of the vehicle may be recorded with a camera 112. According to some embodiments, the image may be stored in a storage unit located on the traffic monitoring system, such as in the base unit 410. According to other embodiments, the image may be transmitted to a remote location for storage.

According to certain embodiments, the steps 604-608 in FIG. 6 and the steps 704-704 in FIG. 7 may be performed by a single deployed traffic monitoring system.

While the foregoing is directed to embodiments of the present invention, other and further embodiments of the invention may be devised without departing from the basic scope thereof, and the scope thereof is determined by the claims that follow.

1. A system for monitoring traffic, comprising:
a portable base unit comprising a control unit; and
at least one camera coupled to the portable base unit, wherein the control unit is configured to:
identify a traffic violation in a traffic monitoring location; and
control the at least one camera to capture at least one image corresponding to the traffic violation.

2. The system of claim 1, further comprising at least one storage device configured to store the at least one image captured by the at least one camera.

3. The system of claim 2, wherein the at least one storage device is further configured to store information corresponding to the traffic violation.

4. The system of claim 1, wherein the at least one image comprises at least one image of a license plate of a vehicle corresponding to the traffic violation.

5. The system of claim 1, wherein the at least one camera is mounted on a pole which is mounted on the portable base unit.

6. The system of claim 5, wherein the pole is a telescoping pole.

7. The system of claim 1, wherein the at least one camera can be controlled to rotate through about 270°.

8. The system of claim 1, wherein the portable base unit comprises a wheeled trailer.

9. The system of claim 8, wherein the portable base unit further comprises two or more outriggers configured to selectively stabilize the portable base unit.

10. The system of claim 1, further comprising a transmitter configured to transmit the at least one image for storage in a storage device at a location remote from the portable base unit.

11. The system of claim 1, wherein the control unit is further configured to receive a traffic signal state from a traffic control device and to control the at least one camera in response to the traffic signal state.

12. The system of clam 11, wherein the control unit is further configured to receive the traffic signal state via a wireless transmission.

13. The system of claim 1, further comprising a speed detection device mounted to the portable base unit.

14. The system of claim 13, wherein the control unit is further configured to receive a signal indicative of a speed detected by the speed detection device and to control the at least one camera in response to the speed detected.

15. The system of claim 1, further comprising at least one secondary camera coupled to the portable base unit, wherein the secondary camera is configured to monitor the portable base unit.

16. A method for monitoring traffic, comprising:
monitoring a traffic monitoring location with a portable traffic monitoring apparatus comprising:
a portable base unit having a control unit; and
a camera coupled to the portable base unit;
detecting a traffic violation at the traffic monitoring location with the control unit; and
capturing, with the camera, at least one image corresponding to the traffic violation.

17. The method of claim 16, further comprising receiving in the control unit at least one signal corresponding to the traffic violation.

18. The method of claim 16, wherein:
the portable traffic monitoring apparatus comprises a speed detection device; and
monitoring the traffic monitoring location comprises detecting a speed of a vehicle in the traffic monitoring location with the speed detection device.

19. The method of claim 18, further comprising:
determining whether the detected speed is in excess of a predetermined speed;
and wherein capturing the at least one image comprises capturing, based on the determination, at least one image of the vehicle with the at least one camera.

20. The method of claim 16, further comprising:
receiving in the control unit a traffic signal state from a traffic control device; and
wherein monitoring the traffic monitoring location comprises selectively monitoring the traffic monitoring location based on the traffic signal state.

21. The method of claim 16, further comprising storing the at least one image in a storage unit mounted to the portable base unit.

22. The method of claim 16, further comprising transmitting the at least one image for storage in a storage unit at a location remote from the portable base unit.

23. The method of claim 16, wherein capturing the at least one image comprises capturing, with the camera, at least one image of a license plate of a vehicle corresponding to the traffic violation.

24. The method of claim 16, further comprising deploying the portable traffic monitoring apparatus proximate to a traffic monitoring location.

25. The method of claim 24, wherein the traffic monitoring location is a first traffic monitoring location, the method further comprising redeploying the portable traffic monitoring apparatus proximate to a second traffic monitoring location different from the first traffic monitoring location.

26. The method of claim 16, further comprising selectively stabilizing the portable base unit with two or more outriggers coupled to the portable base unit.

27. The method of claim 16, further comprising monitoring the portable base unit with another camera coupled to the portable base unit.

28. A portable apparatus for monitoring traffic, comprising:
means for allowing deployment of the apparatus at a traffic monitoring location;
means for detecting a traffic violation at the traffic monitoring location; and
means for capturing at least one image corresponding to the traffic violation.
